(19) United States
(12) Patent Application Publication
(10) Pub. No.: US 2005/0146083 A1
(43) Pub. Date: Jul. 7, 2005

(54) Method and device for transferring a pattern

(76) Inventor: Lennart Olsson, Malmo (SE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/516,608

(22) PCT Filed: Jun. 16, 2003
(86) PCT No.: PCT/SE03/01003

Related U.S. Application Data
(60) Provisional application No. 60/389,890, filed on Jun. 20, 2002.

(30) Foreign Application Priority Data
Jun. 20, 2002 (SE) 0201912-3

(51) Int. Cl. B29C 59/00

(52) U.S. Cl. 264/404; 264/293; 425/174.6; 425/406

(57) ABSTRACT

A method and a device for transferring a pattern in the form of a structure from a pressing means to a layer on a substrate. The layer is heated by a current being supplied through the pressing means in contact with the layer.

### FIELD OF THE INVENTION

The present invention relates to a method and a device for heating a substrate when transferring a pattern from a stamp to a substrate by pressing. More specifically, it relates to a method and a device in connection with so-called nanoimprint lithography or hot embossing.

### BACKGROUND ART

The present application relates to lithography by pressing a stamp with a pattern into a deformable film on a substrate. To allow pressing of the pattern from the stamp into the film, the film has to be sufficiently soft. This is usually achieved by heating the film so as to make it soft. This has previously been done, for instance, by heating the substrate from one of its sides by means of a hot plate. One problem of this technique is that the heating is not homogeneous. This problem is particularly important in connection with so-called nanoimprint lithography in which the structures which are to be transferred are in the order of nanometers.

PCT application WO 01/63361 discloses a method and a device for homogeneous heating of a substrate. This is achieved by providing a heat-absorbing layer, which is arranged so that a homogeneous thermal distribution is obtained in the layer. The heat is subsequently transferred to the substrate.

When heating a substrate in the above manner, a homogeneous heating is obtained over the surface of the substrate. Nevertheless one side of the substrate is heated faster than the other, which may result in the substrate bending.

If the pattern has to be transferred from the stamp to the substrate with a high degree of accuracy, it is desirable to avoid bending of the substrate. Consequently, there is a need for a method and a device which in a more homogeneous manner heat a layer on a substrate when transferring a pattern from a stamp to the layer.

### SUMMARY OF THE INVENTION

The present invention is intended to provide a method and a device which overcome at least one of the problems identified above.

An object of the present invention is to provide a method for transferring a pattern from a stamp to a layer on a substrate by pressing, the layer being heated homogeneously.

It is also an object of the present invention to provide a method for transferring a pattern from a stamp to a layer on a substrate by pressing, the layer being heated in a fast and controllable manner.

A further object of the present invention is to provide a device for transferring a pattern from a stamp to a layer on a substrate by pressing, the layer being heated homogeneously.

One more object of the present invention is to provide a device for transferring a pattern from a stamp to a layer on a substrate by pressing, the layer being heated in a fast and controllable manner.

At least one of these objects is achieved by a method or a device according to the independent claims.

Further advantages of the invention are stated in the dependent claims.

According to the invention, a method for transferring at least one pattern in the form of a structure from a pressing means to a substrate, which is coated with a layer on at least one planar surface, is characterized in that it comprises the following steps: connecting a power source over the pressing means, operating the power source so that a current is passed through the pressing means and heats the pressing means and the layer, which is in contact with the pressing means, arranging the pressing means, which has a surface with a structure that defines the pattern, said pattern facing the layer, and pressing the pressing means against the layer so that the pattern is transferred to the layer.

Since the pressing means is heated by a current being passed therethrough, a considerably more homogeneous heating of the pressing means and the layer is allowed, as compared to prior art technique. The method according to the invention is particularly useful in so-called nanoimprint lithography in which the size of the structures which are to be transferred is in the order of nanometers.

Naturally, in a method according to the invention the pressing means has to be electrically conducting.

According to one embodiment of the invention, the power source is connected so as to render the current density in the pressing means homogeneous. This can be achieved in a number of ways. The power source being connected in this manner and considering the shape of the pressing means, it is possible to connect the pressing means in a suitable manner. If the pressing means is rectangular, the power source can be connected along a pair of opposed sides, the power source being connected along the entire side of each one of the opposed sides.

If the resistivity increases as the temperature rises, the substrate will be heated in a self-regulating manner. It is thus advantageous to make the pressing means of a material which has a resistivity that increases as the temperature rises.

According to an alternative embodiment, the method further comprises the step of providing a pressing means which is formed so that the current density in the pressing means will be homogeneous. If the pressing means has the shape of a trapezoid, the pressing means is suitably formed so as to be thickest at the end which is closest to the shortest side of the two parallel sides of the trapezoid. The pressing means is connected to the power source along the entirety of the two parallel sides.

If the pressing means has an outer periphery and a hole which defines an inner periphery, the power source is advantageously connected between the inner periphery and the outer periphery.

If a homogeneous current density in the substrate is desirable, the substrate is made thicker at the inner periphery. It is particularly advantageous to have a circular symmetrical pressing means.

Naturally, it is possible to connect the connecting means in a number of ways, also when the pressing means is circular-symmetrical with an inner and an outer periphery. According to one embodiment, the power source is connected with the aid of two connecting means, which each extend in the radial direction of the pressing means.

In some cases, it may be difficult to provide a homogeneous current density when the pressing means is irregular in shape. According to one embodiment of the invention, the step of connecting the pressing means to a power source comprises the steps of arranging the substrate in a recess in an electrically conducting holder means with a rectangular outer shape, and connecting the holder means to the power source, the pressing means having electrical contact along it entire periphery, and the combination of holder means and pressing means having the same electrical properties as a rectangular plate. In this manner, it is relatively easy to provide a homogeneous current density in the pressing means.

According to one aspect of the invention, a device is provided for transferring at least one pattern from a pressing means with a structure to a plate shaped substrate, which is coated with a layer on a planar surface, comprising a first holder means for receiving the substrate, a second holder means for receiving the pressing means, the device being arranged to apply a pressure between the first holder means and the second holder means. The device is characterized in that it further comprises a power source for heating the pressing means, and electrical connecting means for connecting the pressing means to the power source.

According to one embodiment of the invention, the first holder means comprises a rectangular portion with a recess which is formed to receive the pressing means, which portion is connected on two opposed sides to the electrical connecting means and has the same resistivity as the substrate and which portion together with the pressing means forms a unit with the same electrical properties as a rectangular plate without a recess.

As a result, it is relatively easy to provide a homogeneous current density in the substrate.

To avoid thermal strain in the pressing means, the pressing means, according to tone embodiment, is resiliently connected to the power source. According to an alternative embodiment, the pressing means is in moving contact with the connecting means to enable the pressing means to slide in relation to the connecting means.

It goes without saying that the different features of the device can be combined with each other in the same way as the different features of the method can be combined with each other. Furthermore, the, different features of the device are applicable to the method and vice versa.

Below various embodiments of the invention will be described with reference to the accompanying drawings.

### BRIEF DESCRIPTION OF THE DRAWINGS

FIG. 1 illustrates a method according to the invention.

FIG. 2 shows a pressing means with connecting means according to an embodiment, of the invention.

FIG. 3 shows a pressing means arranged in a portion according to an alternative embodiment of the present invention.

FIG. 4 shows a pressing means according to an alternative embodiment of the present invention.

FIG. 5 shows a device according to an embodiment of the invention.

FIG. 6 shows two different embodiments for connection of connecting means to the pressing means.

FIG. 7 shows a further embodiment for connection of connecting means to a pressing means.

### DESCRIPTION OF EMBODIMENTS OF THE INVENTION

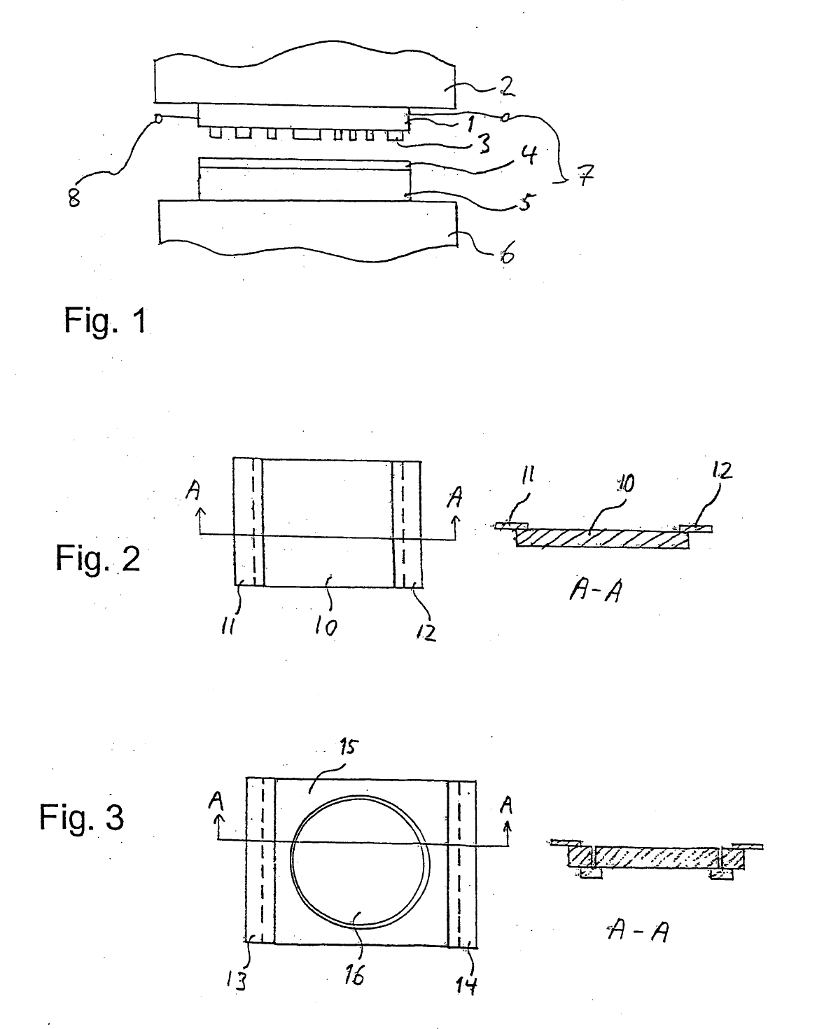

FIG. 1 illustrates a method according to the invention. A pressing means 1 is arranged on a first holder means 2. The pressing means 1 is provided with a pattern 3 in the form of raised portions on one of its sides. The pattern 3 is facing a layer 4 which is arranged on a substrate 5. The substrate 5 is arranged on a second holder means 6. A first connecting means 7 and a second connecting means 8 are arranged on one side each of the substrate 5.

When the pattern 3 is to be transferred from the pressing means to the layer, it is necessary to first heat the layer 4 to make, it deformable. For this purpose, a voltage is applied over the connecting means so that a current is passed through the pressing means after the pressing means has been brought into contact with the layer. The connecting means 7, 8 are designed so that the current through the pressing means will have a homogeneous density. The current through the pressing means causes it to be heated and the layer to soften. By measuring the resistance between the connecting means, it is possible to control the temperature so as to attain the desirable temperature.

When the layer is heated to the desirable temperature, a pressure is applied between the first holder means 2 and the second holder means 6, whereby the pattern is transferred to the layer 4.

FIG. 2a shows a rectangular pressing means 10 with a first connecting means 11 and a second connecting means 12 arranged on one side each of the pressing means 10. Each of the connecting means is in contact with the pressing means along the entire side of one of the sides of the pressing means, thereby ensuring a homogeneous current density in the pressing means. FIG. 2b is a cross-sectional view of the pressing means.

FIG. 3 shows how a first connecting means 13 and a second connecting means 14 are arranged on a portion 15 in which the pressing means 16 is provided. The pressing means 16 is circular and arranged in a circular recess in the portion 15 with electrical contact between the pressing means and the connecting means along the entire periphery of the pressing means. The portion is made of the same material as the pressing means, which makes the current distribution between the connecting means essentially the same as in the embodiment shown in FIG. 2.

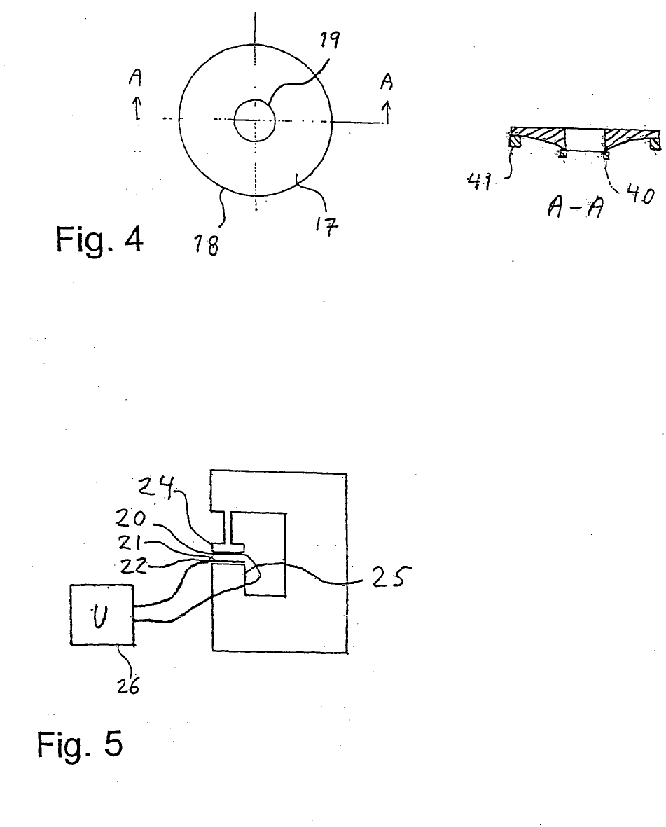

FIG. 4 shows a circular pressing means 17 which is defined by an outer periphery 18 and an inner periphery 19 which defines a circular through hole. When a voltage is applied between the inner and the outer periphery, the current is passed radially through the pressing means. The pressing means 17 is thicker towards the center in such manner that the current density will be constant, which results in a homogeneous heating of the pressing means and thus also of the layer. As an alternative, the pressing means is formed so that a desirable radial temperature distribution is obtained. Connecting means 40, 41 are connected, respectively, at the inner and the outer periphery of the pressing means.

FIG. 5 schematically shows a device for transferring a pattern from a pressing means 20 to a layer 21 on a substrate 22. The device comprises a power unit 23 which is connected to both sides of the pressing means 20. By passing a current through the pressing means it can be heated. The pressing means 20 is arranged on a first holder means 24 whereas the substrate is arranged on a second holder means 25. The device is arranged so that a pressure can be applied between the two holder means. The device also comprises a power source 26, which is intended to be connected to the pressing means.

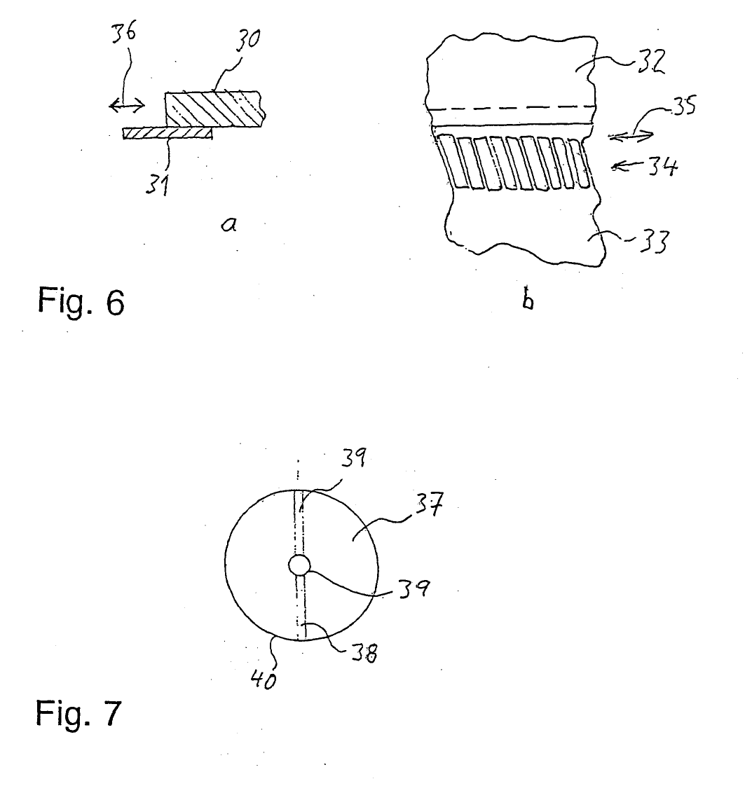

FIG. 6 shows two different embodiments of the connection of connecting means to a pressing means. FIG. 6a is a cross sectional view in which a pressing means 30 is arranged in contact with a carbon path 31. The pressing means 30 rests on the carbon path 31 and can slide towards the carbon path in the direction of the arrow 36. FIG. 6b shows an alternative embodiment in which a pressing means 32 is connected to a connecting means 33, which comprises a resilient portion 34 that allows motion in the direction of the arrow 35. The embodiments shown in FIG. 6 are merely exemplifications which can be applied in the area between the connecting means and the pressing means in one of the embodiments previously described.

FIG. 7 shows yet another embodiment of how the pressing means 37 can be connected to connecting means. In FIG. 7 both the pressing means 37, 38 are radially connected from the inner periphery 39 to the outer periphery 40.

The above embodiments are only to be understood as examples. It is, of course, conceivable to vary the embodiments described in a number of ways within the scope of the claims.

It is not, for instance, necessary to transfer only one pattern to the substrate. It is feasible to arrange a layer and a pressing means on each side of the substrate.

1. A method for transferring at least one pattern in the form of a structure from a pressing means to a deformable layer which is arranged on a planar surface of a substrate, said method comprising the steps of:
connecting a power source over the pressing means,
arranging the pressing means in contact with the layer, the pattern facing the layer,
operating the power source so that a current is passed through the pressing means, which thereby is heated and indirectly heats the layer, and
pressing the pressing means against the layer so that the pattern is transferred to the layer, wherein said power source has at least one contacting surface connected to a contacting surface of said pressing means, said contacting surface of said pressing means having a shape and orientation similar to the contacting surface of said power source, thereby giving a substantially homogeneous current density in said pressing means.

2. (canceled)

3. (canceled)

4. The method according to claim 1, wherein the pressing means has an outer periphery and a hole which defines an inner periphery, and the power source is connected between the inner periphery and the outer periphery.

5. The method according to claim 4, wherein the power source is connected with the aid of two connecting means, which each extend in the radial direction of the pressing means.

6. The method according to claim 1, wherein the step of connecting the pressing means to a power source comprises the steps of:
arranging the pressing means in a recess in an electrically conducting holder means which has a rectangular outer shape, and
connecting the holder means to the power source, wherein the pressing means is brought in electrical contact with the holder means along its entire periphery, thereby giving the combination of holder means and pressing means the same electrical properties as a rectangular plate.

7. A device for transferring at least one pattern in the form of a structure from a pressing means to a deformable layer which is arranged on a planar surface of a plate-shaped substrate, comprising
a first holder means, and
a second holder means for receiving the substrate and the pressing means, respectively, the device being arranged to apply a pressure between the first holder means and the second holder means, wherein said device further comprises:
a power source for heating the pressing means, and
electrical connecting means for connecting the pressing means to the power source, wherein said power source's connecting means has contacting surfaces connected with contacting surfaces of said pressure means, said contacting surfaces of said pressure means having a shape and orientation similar to said power source's connecting means, giving a substantially homogeneous current density in said pressure means.

8. A device as claimed in claim 7, wherein the pressing means has an inner periphery and an outer periphery, and the power source is connected between the inner periphery and the outer periphery.

9. A device as claimed in claim 8, wherein the thickness of the pressing means decreases with an increasing distance from the inner periphery.

10. A device as claimed in claim 7, wherein the first holder means comprises a rectangular portion with a recess which is formed to receive the pressing means, which portion is connected on two opposed sides to the electrical connecting means and has the same resistivity as the substrate and which portion together with the pressing means forms a unit with the same electrical properties as a rectangular plate without a recess.

11. A device as claimed in claim 7, wherein the pressing means is resiliently connected to the power source.

12. A device as claimed in claim 7, wherein the pressing means is in moving contact with the connecting means to enable the pressing means to slide in relation to the connecting means.
